(19) United States
(12) Patent Application Publication
(10) Pub. No.: US 2004/0133873 A1
(43) Pub. Date: Jul. 8, 2004

(54) System and method for building custom application on an application server

(76) Inventors: Noah Dan, Potomac, MD (US); Damon Anderson, Washington, DC (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/617,360

(22) Filed: Jul. 11, 2003

Related U.S. Application Data
(60) Provisional application No. 60/394,866, filed on Jul. 11, 2002.

(51) Int. Cl. G06F 9/44

(52) U.S. Cl. 717/100

(57) ABSTRACT

A system for developing and maintaining a computer application in an enterprise environment, beginning with an incomplete application, preferably on an application server in a Java enterprise environment. A framework used for completing the incomplete application includes reusable service components and vertical pre-configurations of these components adapted for classes of enterprise environments having a commercially viable customer base, together with a toolkit for using the application's language to build reusable service components from scratch. Completion of the application using the framework is driven by business process requirements of a specified enterprise environment. The application is maintained, responsive to changes in the business process requirements, by using the framework to repeat the completion process with business process requirements revised to incorporate the changes. As more reusable service components become available, vertical pre-configurations may be bundled and shrink-wrapped as full featured applications.

### BACKGROUND OF THE INVENTION

This application claims priority from U.S. Provisional Application S/ No. 60/394,866 filed Jul. 11, 2002 entitled “Method and Apparatus for Building Custom Applications on an Application Server in a Java Enterprise Environment.”

### FIELD OF THE INVENTION

The present invention generally relates to application systems development in an enterprise environment, and in particular to the use of pre-constructed building blocks in such systems.

### BACKGROUND DESCRIPTION

The enterprise environment enables multiple users to contribute and interact with an application on a remote server. The basic functionality of the enterprise environment is shown in FIG. 1A. Users and administrators 10 are able to access the system over the Internet 11. Application servers 20 manage the operation of applications 22 that may reside on multiple servers. Typically, the data will reside in databases 24 on separate servers.

In FIG. 1B there is shown an application-centric approach to the enterprise environment. The application 30 is usually a single application, which is the hub of the environment and the main reason for its existence. The databases 32 for the application may reside on the same or separate servers. Scaling-up and integrating with other applications is difficult, slow and expensive because the applications themselves must be customized to accommodate the enterprise environment. Alternatively, the approach to the enterprise environment may be server-centric as shown in FIG. 1C. Application servers 40 are arranged in an integrated fashion supported by appropriate databases 42, and as the enterprise evolves and scales, multiple applications 44 are required to reside on multiple servers and communicate with multiple databases 42. In this scenario, the application server is promoted to a vital position as the operating environment for enterprise applications. As applications grow in size and complexity to meet ever-expanding requirements, integrating them with the rest of the environment presents a constant challenge. Even when using J2EE-compatible applications with extensible API, integration is slow, expensive and fragile.

Unlike circumstances in which the user simply adapts to the application, in the enterprise environment where the application is a support service to a business process, it is the business process which drives the requirements and the application must be customized and customized again as requirements evolve. This repeated customization is often difficult, time consuming and costly. Consequently, there remains a need for a methodology for structuring applications in an enterprise environment such that applications can be scaled and integrated, responsive to the evolving requirements of the business processes supported by the enterprise environment, without having to break down the finalized code and customize the application in a time consuming and costly manner.

### SUMMARY OF THE INVENTION

It is therefore an object of the present invention to provide a system for structuring application development so as to minimize the need to redo finalized application code.

Another object of the invention is to channel application development efforts away from finalized application code and toward functional building blocks which can be easily adapted to specific enterprise environments, and in particular toward building blocks designed for “vertical” enterprise areas such as law, heathcare, etc. which have commonality in their functional building blocks.

It is also an object of the invention to channel application development efforts in such a fashion so as to delay completion of the product until that point at which the application must be customized, thereby minimizing the extent to which—in addition to the unavoidable customization—the product must be redesigned and rewritten.

A further object of the invention is to provide a development framework within which the shrink-wrap of a delivered but not customized product contains a combination of pre-made services and toolkits for creating new services from scratch.

The invention provides a system for developing and maintaining a computer application in an enterprise environment. The methodology of the invention takes the view that in the prior art applications for the enterprise environment are prematurely completed, leading to repeated and inefficient customizations. Instead of completing an application prematurely, the methodology of the invention is to begin with an incomplete application, constructed in an application language (e.g. on an application server in a Java enterprise environment). The invention provides a framework for completing the incomplete application in a specified enterprise environment. The framework includes reusable service components designed for adaptation to the enterprise area containing the specified enterprise environment. The framework also includes vertical pre-configurations of these components, also adapted to the enterprise area containing the specified enterprise environment, provided the enterprise area has a commercially viable customer base. The framework also includes a toolkit for using the application's language to build reusable service components from scratch Completion of the application using the framework is driven by business process requirements of the specified enterprise environment. The application is maintained, responsive to changes in the business process requirements, by using the framework to repeat the completion process with business process requirements revised to incorporate the changes.

The invention is in essence a framework as shown in FIG. 1D for leveraging an application server platform 50 and supporting databases 54 by building reusable services 52 (e.g “session beans” in a J2EE development environment), by developing pre-configurations of these reusable services, and by developing toolkits for creating new services from scratch, all of which are then made available for completion of an application. By building and deploying the most commonly used functions and services directly on the application server, the invention eliminates the need to scale an entire application. In the preferred J2EE embodiment, this takes advantage of the fact that the API's that comprise J2EE are designed for scalability (i.e. simply adding servers and processing power can satisfy large scaling needs). Further, J2EE's modularity is fully leveraged with an ability to mix and match services. Thus the invention fuses scalability and modularity for application development in an enterprise environment driven by evolution of business process requirements.

To continue to enjoy the full range of “normal” application functionality, legacy applications 58 can be deployed on limited CPU using the methodology provided by the invention. As more reusable services 62 become available as shown in FIG. 1E, they are bundled as full-featured applications 60 in various pre-configured combinations. Shrink-wrapping simplifies commercial aspects of marketing and sales.

### BRIEF DESCRIPTION OF THE DRAWINGS

The foregoing and other objects, aspects and advantages will be better understood from the following detailed description of a preferred embodiment of the invention with reference to the drawings, in which:

FIGS. 1A, 1B and 1C show the prior art approaches toward structuring an enterprise environment. FIG. 1A is a schematic showing the basic functionality of the enterprise environment. FIG. 1B is a schematic showing an application-centric structuring of the enterprise environment. FIG. 1C is a schematic showing an application server-centric structuring of the enterprise environment.

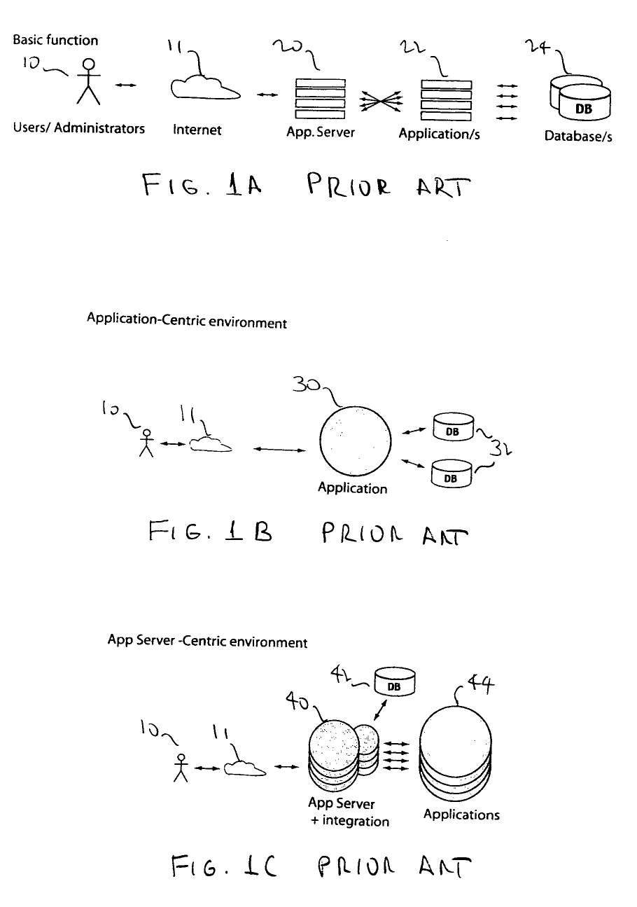

FIG. 1D is a schematic showing application of the invention to an application-centric structuring of the enterprise environment. FIG. 1E is a schematic showing application of the invention to an application server-centric structuring of the enterprise environment.

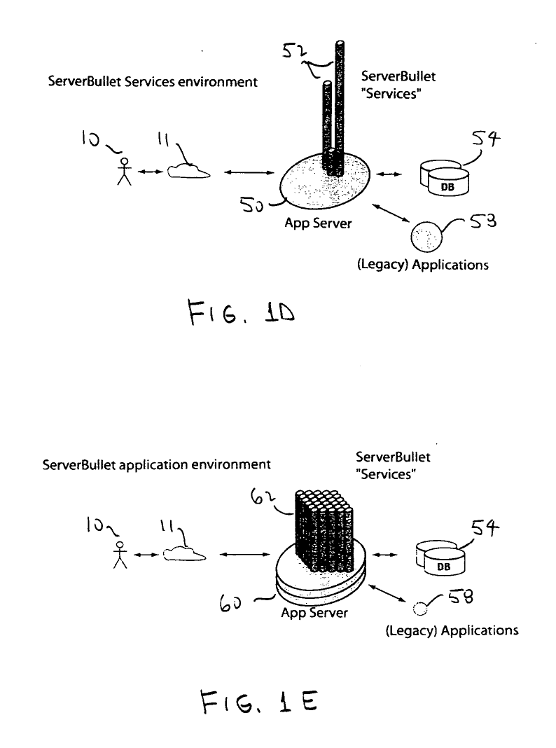

FIG. 2 is a schematic showing the details of the invention implemented within a J2EE development environment.

FIG. 3 is a schematic showing the services of the invention shrink-wrapped as a pre-configured application server application.

FIG. 4A is a schematic showing the development and customization efforts under prior art approaches. FIG. 4B is a schematic showing the allocation of development effort as practiced under the invention. FIG. 4C is a schematic showing alternative completion scenarios for an application developed to completion under prior art approaches.

### DETAILED DESCRIPTION OF A PREFERRED EMBODIMENT OF THE INVENTION

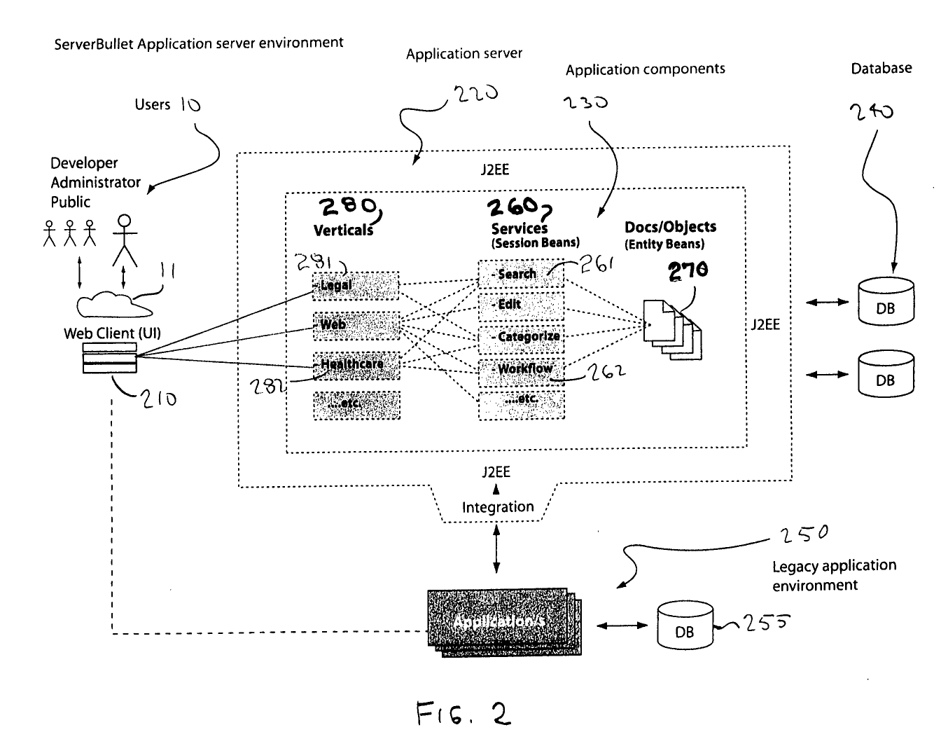

Referring now to the drawings, and more particularly to FIG. 2, there is shown a schematic which illustrates the architecture of the invention as implemented within a J2EE development system serving an enterprise environment. As with the prior art approaches, users 10 (including developers, administrators and general users) access the system over the Internet 11. The system architecture preferably includes a user interface (UI) 210, any J2EE application server 220, a server bullet environment 230, any commercial database application 240, and legacy enterprise applications 250 and associated databases 255 that integrate with J2EE application server 220.

The UI 210 may be a client application or a browser-based web UI.

Application developers will use it to build and modify “server bullet” reusable application service components 260. Administrators will use the interfaces as necessary to administrate and extend the application. Users of the application will use the interface 210 to manage content available to them.

The J2EE application server 220 may be any J2EE Application Server. The server bullet environment 230 includes documents and objects 270 (data or Entity Beans) residing in the database. The reusable services 260 are Session Beans executing functions necessary to perform defined tasks such as, for example: i) search 261: allows user to conduct complex database searches through different bodies of content using different criteria; ii) workflow 262: provides the ability by supervisors to control the progress of work and the release or publication of documents. The environment 230 also includes verticals 280, which are preconfigured sets of services that are tuned to serve the needs of a particular enterprise such as, for example:

i) Legal 281: the collection of reusable services will form an application adapted to a legal team's particular discipline or task. The vertical will pre-configure the reusable services so that, for example, a team in IP litigation will be able to use search tools 261 to perform a combined search through a number of collections of patents, as well as databases of discovery documents and “fish” for particularly meaningful occurrences.

ii) Healthcare 282: a pre-configured vertical will provide a medical team with use of similar tools but with a different vertical interface to search medical database of journals, clinical trials, genomics, etc. to locate meaningful information.

In both these examples code API will be compatible between the search services, so anything which supports the search API (interface) can automatically search from any source, including sources which are added after the application is developed.

The environment 220 is able to use any commercial database application and is able to connect to multiple databases 240. Further, any enterprise applications that integrate with a J2EE App server may benefit from application of the invention. This covers the needs of enterprise users for uncommon functions that need not be scaled up. Typically, applications contain functions to handle any eventuality, and although at any given enterprise many are of limited use, they nevertheless must be on hand. Further, legacy applications 250 typically maintain a relationship with their database 255, and in this configuration the server bullet application 230 will interact only indirectly with the database 255.

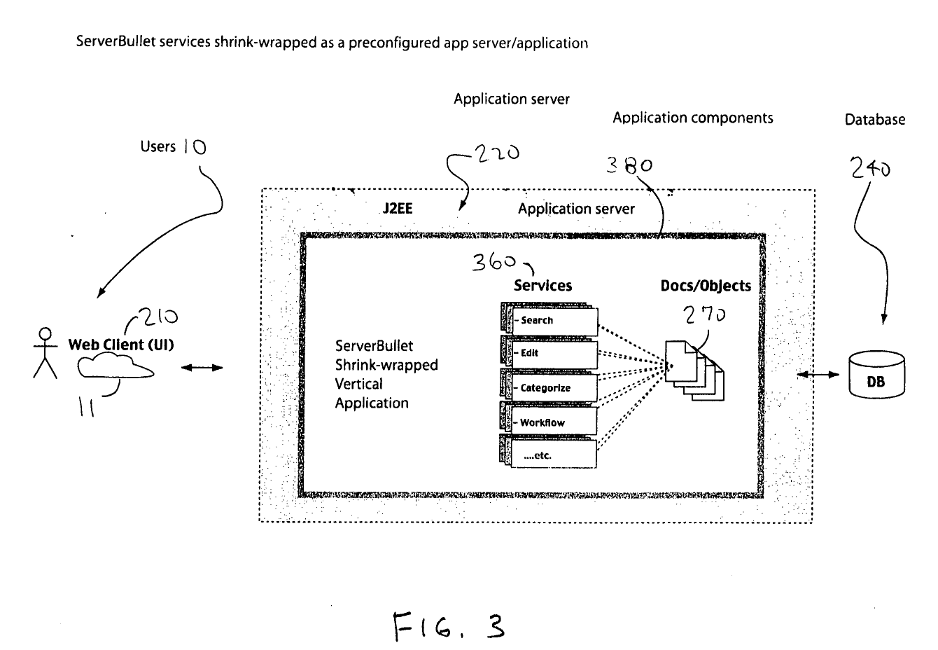

Reference is now made to FIG. 3, which illustrates the architecture of the present invention in accordance with a preferred embodiment. The application server invironment 220 is J2EE, as in FIG. 2. In this embodiment a plurality of reusable service components 360 are pre-configured and shrinkwrapped in a package 380 to emulate the functionality of an enterprise application. Commercial considerations dictate the use of evolved commercial applications having a known market base for such pre-configuration and shrink wrapping, such as Content Management for the legal profession or web publishers, etc.

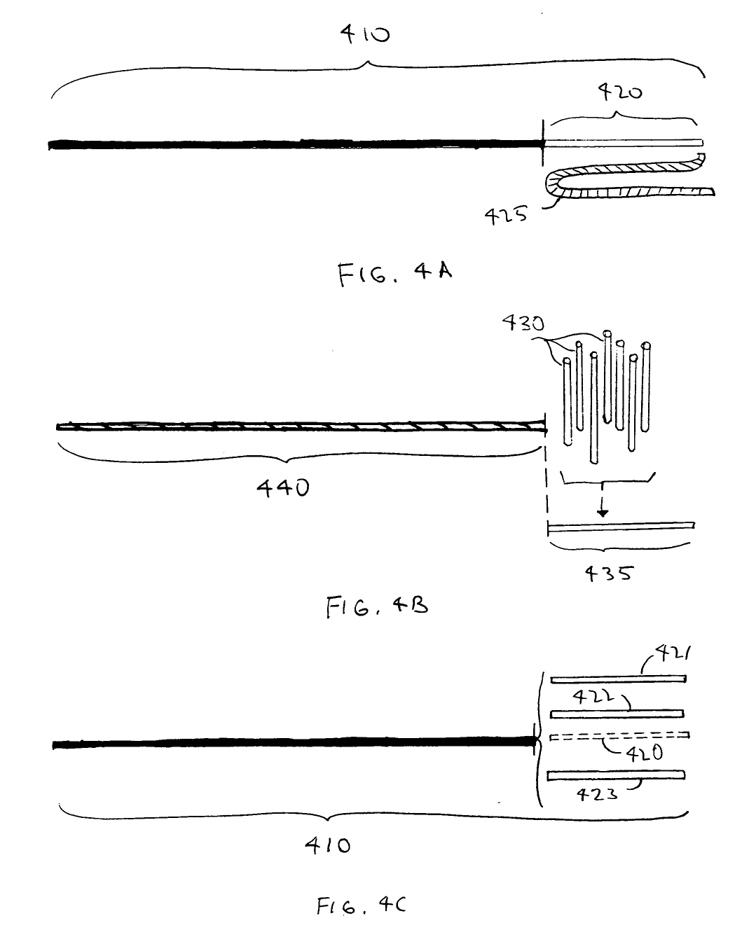

Because each enterprise vertical needs many core services that are essentially compatible functions with different interfaces, the present invention's ability to mix, match and scale gives the application builder an unparalleled ability to develop a wide range of powerful applications with ever-increasing returns. These applications would appear to be very similar to traditional applications in features, much like the way that the Model T was similar to other cars of the period; but the method by which it was put together has set it apart. Similarly, the construction of a single or first application using the invention may not offer to those responsible for an enterprise environment a visible advantage over traditional methods, but as time, requirements, and a library of reusable service components grows, the methodology of the present invention will also set itself apart, as may be seen with reference to FIGS. 4A and 4B.

In traditional methods, a completed application is obtained for an enterprise environment, and then customized to suit the business process requirements of the enterprise environment. What this means in practical terms is shown in FIG. 4A. A completed application 410 is broken down and redone in order to customize the application. The portion of the original development effort 410 that is redone is represented by the segment 420, with the customization being represented by segment 425. Using the system and methodology of the present invention, the development effort formerly expended in prematurely completing the application, as represented by segment 420, is instead channeled into reusable service components 430 (“server bullets”), as shown in FIG. 4B. These provide a platform for an application completion step 435 that is performed later, in lieu of the traditional customization step 425.

The methodology of the invention may require a higher level skill set for design and development of reusable service components 430, which are designed with a view toward the enterprise area where completion of the application (formerly, “customization” under the prior art approaches) will be taking place. The base 440 from which completion is accomplished is an incomplete or non-finalized application. Completion 435 using reusable service components 430 will be less expensive than customization. This expense may be further reduced if the market economies of a particular “vertical” area (such as law, healthcare, etc.) permit “pre-configuration” of the reusable service components 430 in accordance with the known generic characteristics of the business processes of the particular “vertical” area.

The relative inefficiency of the prior art approach may be understood from FIG. 4C, where the premature completion segment 420 is seen in the context of alternative “customizations” 421, 422 and 423 for different enterprise environments with different business process requirements. As not infrequently happens with major applications, the completed product may indeed reflect customization decisions for a particular customer. The alternative customizations 421, 422 and 423 similarly reflect the needs of other potential customers. However, because the application was prematurely completed using 420, the other potential customers who need 421, 422 and 423 find it necessary, under prior art approaches, to customize in the manner shown by segment 425 in FIG. 4A.

Furthermore, the various prior art customizations, each of which is exemplified by segment 425, are performed without any effort at coordination. By using the methodology of the present invention, with a “vertical” view toward the various enterprise areas having their respective and different business process requirements, the practical economic effects of coordination may be achieved through development of a) reusable service components and b) vertical pre-configurations adapted for the various classes of enterprise environments comprising the market for the application.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A system for developing and maintaining a computer application in an enterprise environment, comprising:
an incomplete application, constructed in an application language;
business process requirements applicable to said application in a specified enterprise environment;
a plurality of reusable service components constructed in said language for adaptation to an enterprise area, said enterprise area including said specified enterprise environment;
optionally, a vertical application pre-configuration constructed for adaptation to said enterprise area from said reusable service components; and
a framework for completing said incomplete application using said reusable service components, said optional vertical pre-configuration, and said language, responsive to said business process requirements,
wherein said computer application is maintained responsive to changes in said business process requirements by using said framework to complete said incomplete application using said reusable service components, said optional vertical pre-configuration, and said language responsive to said business process requirements revised to incorporate said changes.

2. A system as in claim 1, wherein said application language is Java.

3. A system as in claim 2, wherein at least one of said reusable service components is a session bean.

4. A system as in claim 3, wherein said framework is used to integrate and maintain a legacy application in said specified enterprise environment.

5. A system as in claim 1, wherein said reusable service components are shrink-wrapped in said vertical pre-configuration.

6. A method for developing and maintaining a computer application in an enterprise environment having a server bullet framework, comprising the steps of:
determining in a specified enterprise environment business process requirements applicable to an incomplete application, said incomplete application having been constructed in an application language;
completing said incomplete application responsive to said business process requirements by using a framework comprised of a plurality of reusable service components for adaptation to an enterprise area, an optional vertical application pre-configuration constructed for adaptation to said enterprise area, and a toolkit for using said language to build reusable service components from scratch, said enterprise area including said specified enterprise environment; and
optionally maintaining said completed application responsive to changes in said business process requirements by repeating said completing step upon said incomplete application responsive to said business process requirements revised to incorporate said changes.

7. A method as in claim 6, wherein said application language is Java.

8. A method as in claim 7, wherein at least one of said reusable service components is a session bean.

9. A method as in claim 8, wherein said framework is used to integrate and maintain a legacy application in said specified enterprise environment.

10. A method as in claim 6, wherein said reusable service components are shrink-wrapped in said vertical pre-configuration.
